(19) United States
(12) Patent Application Publication
(10) Pub. No.: US 2010/0082426 A1
(43) Pub. Date: Apr. 1, 2010

(54) SITE ACTIVATION AND DEACTIVATION

(75) Inventors: Matthew Plummer, Porter Ranch, CA (US); Steven Hartman, Hermosa Beach, CA (US); Timothy Roger Kaiser, Campbell, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/242,549

(22) Filed: Sep. 30, 2008

(51) Int. Cl. G06Q 30/00

(52) U.S. Cl. 705/14.49

(57) ABSTRACT

The present invention is directed towards systems and methods for managing advertisement request data. The method according to one embodiment of the present invention comprises receiving an advertisement request, determining a request type for a received advertisement request and determining request access rights for a website on the basis of whether the website is activated or deactivated. If the request is a booking request and the request is allowed by the access rights, the method is operative to book an advertisement. If the request is an advertisement request and the request is allowed by the access rights, the method is operative to serve advertisements in response to the request.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention described herein generally relate to managing advertisement requests. More specifically, embodiments of the present invention are directed towards systems and methods for managing requests for advertisement booking and serving on the basis of the activation status of a publisher website.

### BACKGROUND OF THE INVENTION

Since the widespread adoption of the Internet as a communication platform, advertising as a main source of revenue has proven to be both effective and lucrative. Advertising on the Internet provides benefits over traditional print and “hard copy” advertising, for example, by allowing advertisers to more effectively target audiences viewing their advertisements.

A primary concern to both advertisers and advertisement providers is to get the most relevant advertisements to as many users as possible. Consequently, great strides have been made in determining users' interests, determining the content of webpages and determining various bidding schemes to maximize revenues for both advertisers and advertisement providers.

While these attempts to enhance the current state of the art have addressed issues regarding client-centric enhancements, few enhancements have been made to increase the efficiency for publishers of content. As webpages created by publishers are the “billboards” of Internet advertising, there exists a need to increase the efficiency of managing publisher websites. The current state of the art disregards the state of publishers when considering advertisement placement. For example, an advertiser may consider an outdated or unfinished website as available for placement of an advertisement. The placement of advertisements on an out of date website, however, substantively diminishes the return on advertisements. Thus there exists a need in the art for systems and methods for managing advertisement requests with respect to the status of publisher websites.

### SUMMARY OF THE INVENTION

The present invention is directed towards systems and methods for managing advertisement request data. The method of the present invention comprises receiving an advertisement request and determining a request type for the received advertisement request. In one embodiment, receiving an advertisement request comprises receiving a request from a website. In an alternative embodiment, receiving an advertisement request comprises receiving a request from an advertiser.

The method determines request access rights for a website on the basis of whether the website is activated or deactivated. In one embodiment, a website is deactivated by default. In an alternative embodiment, a website is deactivated in response to a time-based criterion. In a first embodiment, a deactivated website enables the serving of advertisement and disables the booking of advertisements. Alternatively, a deactivated website may disable the serving of advertisement and disables the booking of advertisements.

The method then books an advertisement request in response to determining the request type is a booking request and the request is allowed by the access rights. Alternatively, the method may return in advertisement in response to determining the request type is a serving request and the request is allowed by the access rights. In one embodiment, a booking an advertisement request comprises associating an advertisement with at least one keyword. Additionally, the method may comprise serving an advertisement associated with a keyword in response to detecting the keyword.

The system of the present invention comprises a content server operative to receive requests for advertisements. In one embodiment, receiving an advertisement request comprises receiving a request from a website. In an alternative embodiment, receiving an advertisement request comprises receiving a request from an advertiser.

The system further comprises an advertisement controller operative to determine a request type for a received advertisement request and determine request access rights for a website on the basis of whether the website is activated or deactivated. In one embodiment, a website is deactivated by default. In an alternative embodiment, a website is deactivated in response to a time-based criterion. In a first embodiment, a deactivated website enables the serving of advertisement and disables the booking of advertisements. Alternatively, a deactivated website may disable the serving of advertisement and disables the booking of advertisements.

The advertisement controller may further be operative to book an advertisement request in response to determining the request type is a booking request and the request is allowed by the access rights. Alternatively, the advertisement controller may return an advertisement in response to determining the request type is a serving request and the request is allowed by the access rights. In one embodiment, a booking an advertisement request comprises associating an advertisement with at least one keyword. Additionally, the method may comprise serving an advertisement associated with a keyword in response to detecting the keyword.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for activating and deactivating a publisher website according to one embodiment of the present invention;

FIG. 2 presents a flow diagram illustrating a method for processing requests for booking and serving of advertisements according to one embodiment of the present invention; and

FIG. 3 presents a flow diagram illustrating a method for processing advertisement booking and serving requests according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

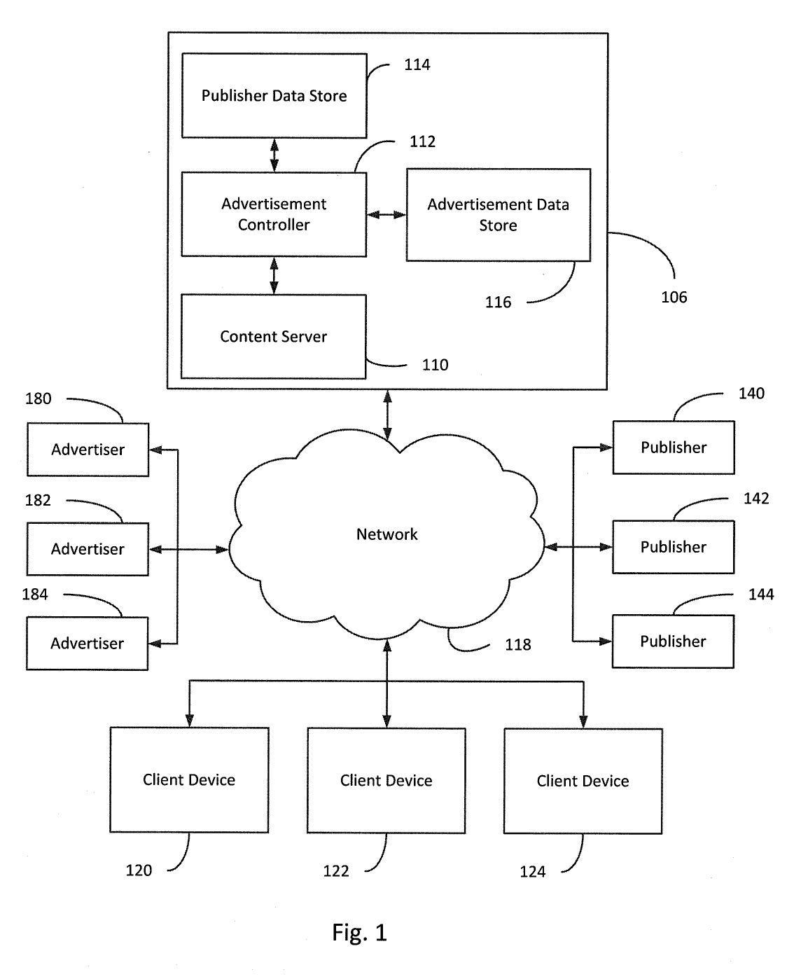

FIG. 1 presents a block diagram depicting a system for activating and deactivating a publisher website according to one embodiment of the present invention. According to the embodiment that FIG. 1 illustrates, one or more publishers 140, 142, 144, client devices 120, 122, 124 and advertisers 180, 182, 184 are coupled to a network 118. Publishers 140, 142, 144, client devices 120, 122, 124 and advertisers 180, 182, 184 may be operative to communicate with a content provider 106 via a network 118. In the illustrated embodiment, content provider 106 comprises a content server 110 (e.g., Apache™, Internet Information Server™, etc.), advertisement controller 112, publisher data store 114 and advertisement data store 116. Publishers 140, 142, 144, clients 120, 122, 124 and advertisers 180, 182, 184 may comprise general purpose computing devices having a central processing unit, memory unit, permanent storage, optical drive(s), universal serial bus port(s), audio/video output devices, network interfaces, etc.

In the illustrated embodiment, a publisher 140, 142, 144a-c comprises a computing device operative to serve webpages to an end user, such as a client device 120, 122, 124. Additionally, a publisher 140, 142, 144a-c may further be operative to communicate with content provider 106 to perform various tasks, as is described in greater detail herein. An advertiser 180, 182, 184 comprises a computing device operative to transmit advertising data to content provider 106. In one embodiment, advertiser 180, 182, 184 transmits advertisement data containing a graphical, textual, audio or video advertisement for storage by content provider 106. Alternatively, or in conjunction with the forgoing, advertiser 180, 182, 184 may transmit advertisement-identifying indicia operative to provide location data for audio, graphical, or video advertisements, such as a URL. In this embodiment, advertisement identifying indicia may be utilized distribute the storage of advertisement data and consequently minimize the throughput burden placed upon the content provider.

In the illustrated embodiment, content provider 106 comprises a content server 110 operative to handle requests for advertisement content received from a plurality of client devices 120, 122, 124. Additionally, content server 110 may be operative to handle requests for advertisement operations from advertisers or publishers, such as requests for the booking of advertisements, or requests for the advertisements themselves. In the illustrated embodiment, content server 110 handles public requests for data and analyzes the incoming queries to determine the destination of the request. For example, content server 110 may receive HTTP requests via HTML elements present within a publisher's webpage. Content server 110 may also receive requests from publishers via a web-based administrative portal transmitting publisher commands via HTTP. In alternative embodiments, content provider 106 may comprise various other controller modules responsible for processing other requests such as analytics processing, reporting processing, security processing and the like. In response to a request for advertisement content, the content server 110 transmits the request to advertisement controller 112 coupled to publisher data store 114 and advertisement data store 116.

Advertisement controller 112 may be operative to perform various administrative tasks prior to processing advertiser or client requests or retrieving an advertisement from advertisement data store 116. Administrative tasks may include determining the access rights of the requests. That is, advertisement controller 112 may admit or deny requests based on access control levels for a given advertiser or publisher. In the illustrated embodiment, advertisement controller 112 is also operative to perform booking or serving requests. In one embodiment, booking or serving requests are based on the access rights associated with the request. For example, a request may be able to booking advertisements but may not be able to receive advertisements (i.e., serving requests).

In one embodiment, a booking request comprises associating an advertisement within at least one keyword. For example, an advertiser 180, 182, 184a-c may transmit advertising data to content provider 106 and may book the advertisement data against the keywords “soccer” and “premiership”. By booking advertisements, the content provider agrees to display advertisements in accordance with the booking requirements submitted by the advertiser. Continuing with the previous example, the content provider 106 may agree to display the received advertising data on webpages containing the terms “soccer” or “premiership”. In alternative embodiments, the content provider 106 may utilize other booking schemes in place of, or in conjunction with, keyword-based booking schemes. For example, content provider 106 may book advertisements against metadata supplied by publishers or against specific publishers, e.g., according to domain based constraints. Content provider 106 additionally processes serving requests. In one embodiment, a serving request may comprise a request from a publisher website for advertising content, as previous described.

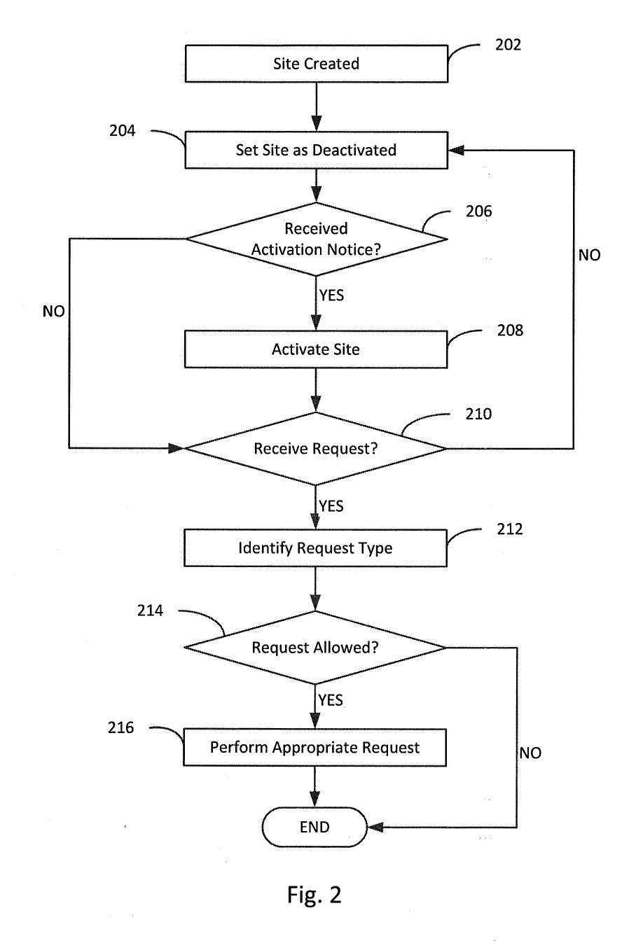

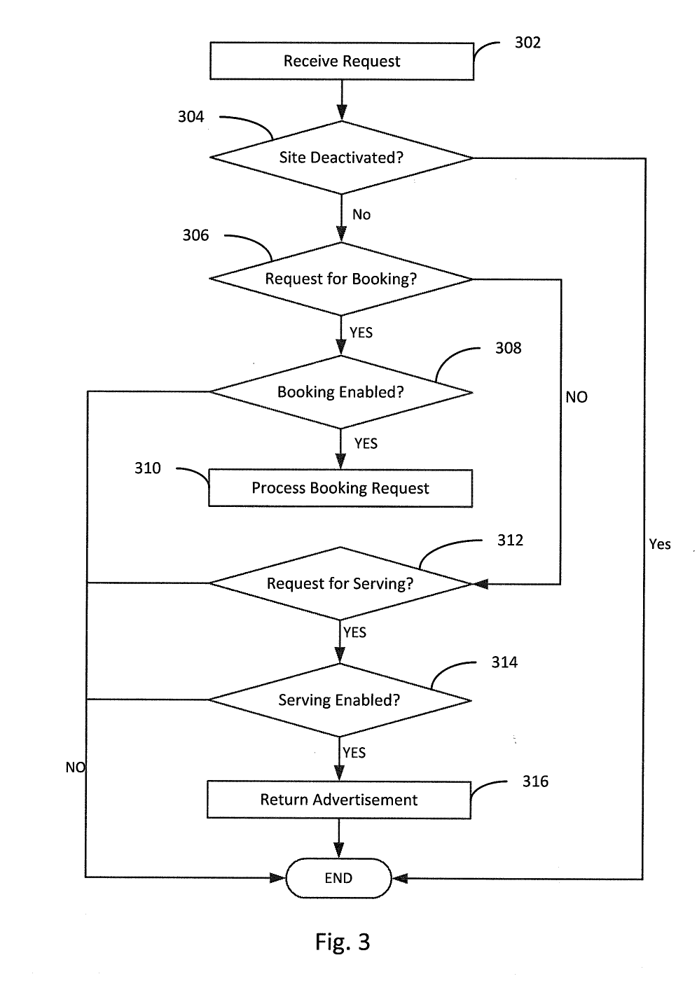

In a first embodiment, advertisement controller 112 returns advertisement content to content server 110, which in turn, transmits advertising data to client devices 120, 122, 124. In this particular embodiment, advertisement controller 112 queries publisher data store 114 to determine if a publisher webpage initiating the request is operative to receive advertisement content. In one embodiment, a publisher explicitly or implicitly disables his or her site from having advertisements booked. For example, upon creation of a website, content provider 106 may determine that the newly created website should be flagged as inactive until explicitly activated by a website owner. Advertisement controller 112 may additionally process or audit incoming requests to determine whether or not the requested action is available for a given advertisement or publisher. The process of auditing requests is discussed more fully with respect to FIGS. 2 and 3.

The system 100 further comprises client devices 120, 122, 124 comprising computing devices operative to display webpages in response to user input, such as entering a uniform resource locator (“URL”) into a location bar of a web browser or selecting a hyperlink containing a URL. Webpages may be pages associated with a website administered by a publisher 140, 142, 144 as known in the art. In response to displaying a webpage, a client device 102 may request advertisement content from content provider 106 via network 118. As previously described, a request for advertisement content may be routed to the advertisement controller 112 via content server 110. In one embodiment, a request for advertisement content comprises an automatic request triggered by a webpage provided by a given publisher 140, 142, 144. For example, a webpage provided by a publisher 108 may comprise an HTML tag instructing a client device to retrieve third party advertisements from content provider 106.

FIG. 2 presents a flow diagram illustrating a method for processing requests for booking and serving of advertisements according to one embodiment of the present invention. The method 200 first creates a website, step 202. In one embodiment, creating a site comprises creating a website and indicating, to a third party, the creation of the site. For example, a publisher may create a website and transmit website identifying information (e.g., a URL) to an advertisement provider via a form provided by the advertiser.

The method 200 then sets the created site as deactivated, step 204. In one embodiment, setting a site as deactivated comprises updating control values associated with a website, such as a true or false bit within a database table. In the illustrated embodiment, the method 200 automatically deactivates websites upon creation. In this embodiment, deactivation of a website acts as a safeguard to prevent advertisements from being displayed on website deemed unfit to display advertisements. Deactivation also allows site owners to finalize a website design or content before committing to the display of advertisements. Alternatively, or in conjunction with the foregoing, deactivation may still allow publishers access to other publisher operations including, but not limited to, creating of custom sections, custom categorization and inventory identification. In an alternative embodiment, deactivation of a site may occur at a pre-defined time, such as the end of a campaign determined by the publisher.

After a site is deactivated, the method 200 determines if an activation notice is received for the website, step 206. In one embodiment, activation comprises a notification from a website owner or developer indicating that the website is available for advertisement serving or booking. In response to receiving an activation notification, the method 200 activates the website, step 208. In one embodiment, activating a website comprises updating a record within a database maintained by the advertisement provider indicating the activation of the website.

According to the illustrated embodiment, the method 200 receives a plurality of requests, step 210. In one embodiment, a request comprises a request from a third party, such as an advertiser. For example, a request may comprise a request from an advertiser to book a given website for advertisement placement. Alternatively, or in conjunction with the foregoing, a request may comprise an internal or client request to serve advertisements. For example, in response to a request from a client device, the method 200 may determine whether the website is allowed to display advertisements. If the method 200 does not receive a request, the method 200 may continue to monitor for incoming requests for a given website. However, if the method 200 receives a request for a given website may be operative to identify the request type, step 212, and determine if the request is allowed, step 214. In one embodiment, request types comprise requests for booking and requests for serving.

In the illustrated embodiment, determining if the request is allowed comprises querying data associated with a given website. For example, a given website may be operative to receive booking requests, but not for serving requests. That is, a website may be able to be booked for future advertisements, but may not be able to display advertisements. In response to receiving a request, the method 200 may query a data store containing control values associated with the selected website, the control values indicating whether or not the request is able to be processed for the selected website, and if so, how to process the request.

If the method 200 may determine that a given website is capable of responding to the received request, the method 200 performs the appropriate action, step 216. As previously discussed, actions may comprise advertisement based actions such as booking advertisements or serving advertisement content. Alternatively, if the method 200 determines that a given website is incapable of responding to the request, the method 200 ends.

FIG. 3 presents a flow diagram illustrating a method for processing advertisement booking and serving requests according to one embodiment of the present invention. As illustrated, the method 300 receives a request; step 302. In one embodiment, a request may comprise a booking request received from a prospective advertiser. Alternatively, a request may comprise a request for advertising content from a view of a publisher website.

The method 300 may first determine if the site is deactivated, step 304. If the site is deactivated, the method 300 ends. In alternative embodiments, various other deactivated “states” may exist wherein various actions are enabled for a given site. For example, a deactivated site may be operative to receive serving requests but may not be operative to receive booking requests, and vice-versa.

If the method 300 detects that a request for booking has been received, step 306, the method 300 determines if booking is enabled, step 308. If booking is enabled, the method 300 processes the booking request, step 310. In one embodiment, processing a booking request may comprise associating an advertisement with a plurality of advertising terms such as keywords. In an alternative embodiment, a processing a booking request may comprise associating an advertisement with an advertiser-selected website.

If the method 300 detects that a request for serving has been received, step 312, the method 300 determines if serving is enabled, step 314. If serving is enabled, the method 300 returns the appropriate advertisement, step 316. In one embodiment, returning an advertisement may comprise transmitting a graphical, textual, audio or video advertisement to a requesting party. In the illustrated embodiment, the requesting party comprises an end user viewing a publisher website.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for managing advertisement request data, the method comprising:
determining a request type for a received advertisement request;
determining request access rights for a website on the basis of whether the website is activated or deactivated;
booking an advertisement request in response to determining that the request type is a booking request and the request is allowed by the access rights; and
returning an advertisement in response to determining that the request type is a serving request and the request is allowed by the access rights.

2. The method of claim 1 wherein receiving an advertisement request comprises receiving a request from a website.

3. The method of claim 1 wherein receiving an advertisement request comprises receiving a request from an advertiser.

4. The method of claim 1 wherein booking an advertisement request comprises associating an advertisement with at least one keyword.

5. The method of claim 4 further comprising serving an advertisement associated with a keyword in response to detecting the keyword.

6. The method of claim 1 wherein a website is deactivated by default.

7. The method of claim 1 wherein a website is deactivated in response to a time-based criterion.

8. The method of claim 1 wherein a deactivated website enables advertisement serving and disables advertisement booking.

9. The method of claim 1 wherein a deactivated website disables advertisement serving and disables advertisement booking.

10. The method of claim 1 wherein a website is activated in response to a time-based criterion.

11. The method of claim 1 wherein an activated website enables advertisement serving and disables advertisement booking.

12. The method of claim 1 wherein an activated website enables advertisement serving and enables advertisement booking.

13. A system for managing advertisement request data, the system comprising:
a content server operative to receive requests for advertisements;
an advertisement controller operative to:
determine a request type for a received advertisement request;
determine request access rights for a website on the basis of whether the website is activated or deactivated;
book an advertisement request in response to determining that the request type is a booking request and the request is allowed by the access rights; and
return an advertisement in response to determining that the request type is a serving request and the request is allowed by the access rights.

14. The system of claim 13 wherein receiving an advertisement request comprises receiving a request from a website.

15. The system of claim 13 wherein receiving an advertisement request comprises receiving a request from an advertiser.

16. The system of claim 13 wherein booking an advertisement request comprises associating an advertisement with at least one keyword.

17. The system of claim 16 wherein the advertisement controller is further operative to serve an advertisement associated with a keyword in response to detecting the keyword.

18. The system of claim 13 wherein a website is deactivated by default.

19. The system of claim 13 wherein a website is deactivated in response to a time-based criterion.

20. The system of claim 13 wherein a deactivated website enables advertisement serving and disables advertisement booking.

21. The system of claim 13 wherein a deactivated website disables advertisement serving and disables advertisement booking.

22. The system of claim 13 wherein a website is activated in response to a time-based criterion.

23. The system of claim 13 wherein an activated website enables advertisement serving and disables advertisement booking.

24. The system of claim 13 wherein an activated website enables advertisement serving and enables advertisement booking.

25. Computer readable media comprising program code that when executed by a programmable processor causes the programmable processor to execute a method for managing advertisement request data, the computer readable media comprising:
program code for determining a request type for a received advertisement request;
program code for determining request access rights for a website on the basis of whether the website is activated or deactivated;
program code for booking an advertisement request in response to determining that the request type is a booking request and the request is allowed by the access rights; and
program code for returning an advertisement in response to determining that the request type is a serving request and the request is allowed by the access rights.

26. The computer readable media of claim 25 wherein receiving an advertisement request comprises receiving a request from a website.

27. The computer readable media of claim 25 wherein receiving an advertisement request comprises receiving a request from an advertiser.

28. The computer readable media of claim 25 wherein booking an advertisement request comprises associating an advertisement with at least one keyword.

29. The computer readable media of claim 28 further comprising program code for serving an advertisement associated with a keyword in response to detecting the keyword.

30. The computer readable media of claim 25 wherein a website is deactivated by default.

31. The computer readable media of claim 25 wherein a website is deactivated in response to a time-based criterion.

32. The computer readable media of claim 25 wherein a deactivated website enables advertisement serving and disables advertisement booking.

33. The computer readable media of claim 25 wherein a deactivated website disables the serving of advertisement and disables the booking of advertisements.

34. The computer readable media of claim 25 wherein a website is activated in response to a time-based criterion.

35. The computer readable media of claim 25 wherein an activated website enables advertisement serving and disables advertisement booking.

36. The computer readable media of claim 25 wherein an activated website enables advertisement serving and disables advertisement booking.
